(19) United States
(12) Patent Application Publication
(10) Pub. No.: US 2020/0398568 A1
(43) Pub. Date: Dec. 24, 2020

(54) SAMPLED AND HELD ZONAL ACTUATOR EVALUATION THRESHOLDS

(71) Applicant: Hewlett-Packard Development Company, L.P., Spring, TX (US)

(72) Inventors: Daryl E. Anderson, Corvallis, OR (US); Eric Martin, Corvallis, OR (US); James Michael Gardner, Corvallis, OR (US)

(73) Assignee: Hewlett-Packard Development Company, L.P., Spring, TX (US)

(21) Appl. No.: 16/956,114

(22) PCT Filed: Mar. 5, 2018
(86) PCT No.: PCT/US2018/020872

§ 371 Date: Jun. 19, 2020

(51) Int. Cl. B41J 2/14; B41J 2/145

(52) U.S. Cl. CPC B41J 2/14072; B41J 2/145

(57) ABSTRACT

In one example in accordance with the present disclosure, a fluidic die is described. The fluidic die includes an array of fluid actuators grouped into zones. Each zone has at least one comparator to compare at least one of a representation of a supply voltage and a return voltage supplied to a zone of fluid actuators against a supply voltage threshold. Each zone also includes at least one sample and hold device to 1) receive and store the voltage threshold during a predetermined period and 2) pass the voltage threshold to the at least one comparator during evaluation.

### BACKGROUND

A fluidic die is a component of a fluidic system. The fluidic die includes components that manipulate fluid flowing through the system. For example, a fluidic ejection die, which is an example of a fluidic die, includes a number of nozzles that eject fluid onto a surface. The fluidic die also includes non-ejecting actuators such as micro-recirculation pumps that move fluid through the fluidic die. Through these nozzles and pumps, fluid, such as ink and fusing agent among others, is ejected or moved.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a fluidic die with sampled and held zonal actuator evaluation thresholds, according to an example of the principles described herein,

FIG. 2 is a block diagram of a fluidic die with sampled and held zonal actuator evaluation thresholds, according to an example of the principles described herein.

FIG. 3 is a flow chart of a method for zonal actuator evaluation using sampled and held thresholds, according to an example of the principles described herein.

FIG. 4 is a circuit diagram of a fluidic die with sampled and held zonal actuator evaluation thresholds, according to an example of the principles described herein.

FIG. 5 is a circuit diagram of a fluidic die with sampled and held zonal actuator evaluation thresholds, according to another example of the principles described herein.

FIG. 6 is a flow chart of a method for zonal actuator evaluation; according to an example of the principles described herein.

Throughout the drawings, identical reference numbers designate similar, but not necessarily identical, elements. The figures are not necessarily to scale; and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Fluidic dies, as used herein, may describe a variety of types of integrated devices with which small volumes of fluid may be pumped, mixed, analyzed, ejected; etc. Such fluidic dies may include ejection dies, such as those found in printers, additive manufacturing distributor components; digital titration components, and/or other such devices with which volumes of fluid may be selectively and controllably ejected.

In a specific example; these fluidic systems are found in any number of printing devices such as inkjet printers, multi-function printers (MFPs), and additive manufacturing apparatuses. The fluidic systems in these devices are used for precisely, and rapidly, dispensing small quantities of fluid. For example, in an additive manufacturing apparatus; the fluid ejection system dispenses fusing agent. The fusing agent is deposited on a build material, which fusing agent facilitates the hardening of build material to form a three-dimensional product.

Other fluid systems dispense ink on a two-dimensional print medium such as paper. For example, during inkjet printing, fluid is directed to a fluid ejection die. Depending on the content to be printed, the device in which the fluid ejection system is disposed determines the time and position at which the ink drops are to be released/ejected onto the print medium. In this way, the fluid ejection die releases multiple ink drops over a predefined area to produce a representation of the image content to be printed. Besides paper, other forms of print media may also be used.

Accordingly, as has been described, the systems and methods described herein may be implemented in a two-dimensional printing, i.e., depositing fluid on a substrate, and in three-dimensional printing, i.e., depositing a fusing agent or other functional agent on a material base to form a three-dimensional printed product.

Each fluidic die includes a fluid actuator to eject/move fluid. In a fluidic ejection die, a fluid actuator may be disposed in an ejection chamber, which chamber has an opening. The fluid actuator in this case may be referred to as an ejector that, upon actuation, causes ejection of a fluid drop via the opening.

Fluid actuators may also be pumps. For example, some fluidic dies include microfluidic channels. A microfluidic channel is a channel of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.). Fluidic actuators may be disposed within these channels which, upon activation, may generate fluid displacement in the microfluidic channel.

Examples of fluid actuators include a piezoelectric membrane based actuator, a thermal resistor based actuator, an electrostatic membrane actuator, a mechanical/impact driven membrane actuator, a magneto-strictive drive actuator, or other such elements that may cause displacement of fluid responsive to electrical actuation. A fluidic die may include a plurality of fluid actuators, which may be referred to as an array of fluid actuators.

While such fluidic systems and dies undoubtedly have advanced the field of precise fluid delivery, some conditions impact their effectiveness. For example, the power delivery regime of a fluidic die may not be able to keep up with other technological changes to the fluidic die. For example, as fluidic dies shrink in size to meet consumer demand or as more circuit elements are added between the power source and the array of fluid actuators, power delivery becomes more difficult as there are fewer thin film layers through which power can be delivered and more components that act as a source of parasitic loss. Each of these circumstances may have a deleterious effect on fluidic performance.

For example, the energy a fluid actuator uses to effectuate fluid manipulation is related to the voltage difference across it. Accordingly, a drop in electrical power may affect the fluid actuator's ability to perform an operation such as fluidic ejection or fluidic movement. As a specific numeric example, an actuator array may be optimized to operate when coupled to a 32 V supply voltage and a ground signal. However, due to parasitic losses, which may be more prevalent with reduced size components, the supply voltage that is actually seen by an actuator in the array may be 28 V and the power return node at that same actuator may be 3V instead of 0 on ground, due to parasitic rise. This reduced voltage may result in an actuation of the fluid actuator that is not full strength and thus affects ejection/movement of the fluid, or may not result in any ejection/movement at all. Such losses may be more prevalent at those positions along the array furthest from a power supply or a return, for example, a middle region of a column array. Additionally, for fluidic systems that include multiple fluidic die, fluidic dies that are located further from the system power supply will experience more parasitic losses.

Accordingly, the present specification is directed to a fluidic die that includes multiple arrays of fluid actuators, each of the arrays being divided into zones of fluid actuators. Components within each zone monitor power delivery to fluid actuators in that zone. If a supply voltage level drops below a threshold value or if a return voltage level rises above a threshold value, a fault signal is sent to circuitry that informs the printer. The printer could then make any variety of adjustments including adjusting print masks, power settings, or other parameters to bring the power delivery to each zone back to a desired level. Specifically, a controller could increase the supply voltage, reduce the number of nozzles that are fired at the same time, and slow down the print speed so that the amount of fluid per area remains the same as before, and increase a pulse width of power delivered to the fluid actuators. As such, a device in which the fluidic die is included, can optimize printing based on actual power delivery to the fluidic die and that is specific to that fluidic die.

In this particular example, the supply voltage threshold and the return voltage threshold that are supplied to the comparators are stored by a sample and hold device. This is because at any period of time electrical noise on the fluidic die may obfuscate the threshold voltages. This obfuscation can lead to imprecise threshold voltages being used for comparison and may adversely affect any comparison thereto.

Specifically, the present specification describes a fluidic die. The fluidic die includes an array of fluid actuators grouped into zones. Each zone includes at least one comparator and at least one sample and hold device. The sample and hold device(s) 1) receive and store the voltage threshold during a predetermined period and 2) pass the voltage threshold to the comparator during evaluation. The comparator(s) compares either a representation of a supply voltage or a return voltage supplied to a zone of fluid actuators against a voltage threshold.

The present specification also describes a fluidic die that includes the array of fluid actuators grouped into zones, each zone having a number of fluid actuators, multiple comparators and multiple sample and hold devices. Each zone also includes a number of fault capture devices to store a signal indicating a fault based on an output of at least one of the comparators. The stored signal is output when an output of at least one of the comparators indicates a fault. The fluidic die also includes a detection chain to combine outputs of each fault capture device such that the contents of all fault capture devices in the array are conveyed in a collective fashion to a controller. The controller of the fluidic die 1) determines the predetermined period and 2) enable storage of the voltage thresholds at the sample and hold devices during the predetermined period.

The present specification also describes a method. According to the method, a supply voltage threshold and return voltage threshold are passed to multiple zones of fluid actuators. A predetermined period is determined and during this predetermined period 1) a supply enable signal is sent to enable storage of the supply voltage threshold in a first sample and hold device and 2) a return enable signal is sent to enable storage of the return voltage threshold in a second sample and hold device. In some examples the supply enable signal and the return enable signal may be a single signal.

In one example, using such a fluidic die 1) allows for immediate detection of power faults at a zone level; 2) reports such faults such that remedial action may be taken; 3) allows for a controller to adjust print masks, power distribution, print speed, or other firing parameters, on the fly to optimize for the actual power delivery limitations of the system; 4) may leverage circuitry used for other zonal sensing systems such as drive bubble detection systems; 5) provides noise free threshold voltages to the zones for improved fault detection.

As used in the present specification and in the appended claims, the term “actuator” refers to an ejecting actuator and/or a non-ejecting actuator. For example, an ejecting actuator operates to eject fluid from the fluid ejection die. A recirculation pump, which is an example of a non-ejecting actuator, moves fluid through the fluid slots, channels, and pathways within the fluidic die.

Accordingly, as used in the present specification and in the appended claims, the term “nozzle” refers to an individual component of a fluid ejection die that dispenses fluid onto a surface. The nozzle includes at least an ejection chamber, an ejector actuator, and an opening.

Further, as used in the present specification and in the appended claims, the term “fluidic die” refers to a component of a fluid ejection system that includes a number of fluid actuators. A fluidic die includes fluidic ejection dies and non-ejecting fluidic dies.

Still further, as used in the present specification and in the appended claims, the term “array” refers to a grouping of fluid actuators, A fluidic die may include multiple “arrays.” For example, a fluidic die may include multiple columns, each column forming an array.

Even further, as used in the present specification and in the appended claims, the term “zone” refers to a sub-division of an array. For example, a column of fluid actuators may include multiple zones.

Even further, as used in the present specification and in the appended claims, the term “fault capture device,” refers to an electrical component that can store a signal, such as a logic value. Examples of capture devices include flip-flops such as a set-reset flop, a D flip-flop, and others.

Yet further, as used in the present specification and in the appended claims, the term “fault-indicating output” refers to an output of a comparator that indicates a particular fault. For example, a comparator may generate an output indicating that the supply voltage seen at a zone of fluid actuators is less than a threshold amount, which is indicative of a fault. The comparator may then generate an output indicating this fault.

Even further, as used in the present specification and in the appended claims, the term “fault detection device” refers to hardware components within a zone to determine a fault within that zone. There may be multiple fault detection devices within a zone. For example, a first fault detection device may detect and store a supply fault and a second fault detection device may detect and store a return fault.

Finally, as used in the present specification and in the appended claims, the term “a number of” or similar language is meant to be understood broadly as any positive number including 1 to infinity.

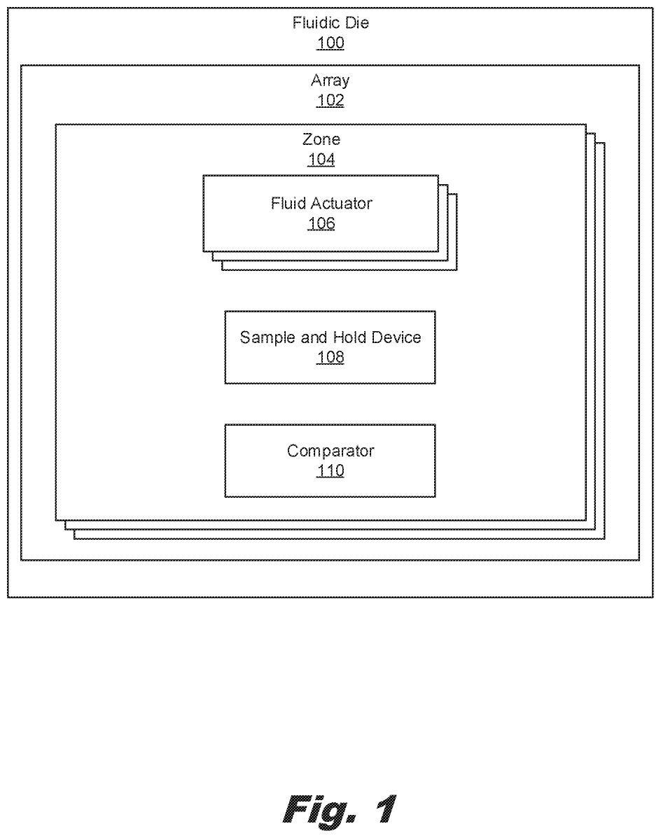

Turning now to the figures, FIG. 1 is a block diagram of a fluidic die (100) with sampled and held zonal actuator evaluation thresholds, according to an example of the principles described herein. As described above, the fluidic die (100) is a part of a fluidic system that houses components for ejecting fluid and/or transporting fluid along various pathways. In some examples, the fluidic die (100) is a microfluidic die (100). That is, the channels, slots, and reservoirs on the microfluidic die (100) may be on a micrometer, or smaller, scale to facilitate conveyance of small volumes of fluid (e.g., picoliter scale, nanoliter scale, microliter scale, milliliter scale, etc.). The fluid that is ejected and moved throughout the fluidic die (100) can be of various types including ink, biochemical agents, and/or fusing agents. The fluid is moved and/or ejected via an array (102) of fluid actuators (106). Any number of fluid actuators (106) may be formed on the fluidic die (100). The fluidic die (100) may include any number of arrays (102). For example, the different arrays (102) on a fluidic die (100) may be organized as columns. In other examples, the array (102) may take different forms such as an N×N grid of fluid actuators (106).

Each array (102) is divided into different zones (104), a zone (104) referring to a sub-grouping of the fluid actuators (106) within a particular array (102). For example, in one column, i.e., array (102), of fluid actuators (106), multiple zones (104) of eight fluid actuators (106) may be present.

The fluidic die (100) includes a number of fluid chambers to hold a volume of the fluid to be move or ejected. The fluid chamber may take many forms. A specific example of such a fluid chamber is an ejection chamber where fluid is held prior to ejection from the fluidic die (100). In another example, the fluid chamber (100) may be a channel, or conduit through which the fluid travels. In yet another example, the fluid chamber (100) may be a reservoir where a fluid is held.

The fluid chambers (100) formed in the fluidic die (100) include fluid actuators (106) disposed therein, which fluid actuators (106) work to eject fluid from, or move fluid throughout, the fluidic die (100). The fluid chambers and fluid actuators (106) may be of varying types. For example, the fluid chamber may be an ejection chamber wherein fluid is expelled from the fluidic die (100) onto a surface for example such as paper or a 3D build bed. In this example, the fluid actuator (106) may be an ejector that ejects fluid through an opening of the fluid chamber.

In another example, the fluid chamber is a channel through which fluid flows. That is, the fluidic die (100) may include an array of microfluidic channels. Each microfluidic channel includes a fluid actuator (106) that is a fluid pump. In this example, the fluid pump, when activated, displaces fluid within the microfluidic channel. While the present specification may make reference to particular types of fluid actuators (106), the fluidic die (100) may include any number and type of fluid actuators (106).

These fluid actuators (106) may rely on various mechanisms to eject/move fluid. For example, an ejector may be a firing resistor. The firing resistor heats up in response to an applied voltage. As the firing resistor heats up, a portion of the fluid in an ejection chamber vaporizes to generate a bubble. This bubble pushes fluid out an opening of the fluid chamber and onto a print medium. As the vaporized fluid bubble collapses, fluid is drawn into the ejection chamber from a passage that connects the fluid chamber to a fluid feed slot in the fluidic die (100), and the process repeats. In this example, the fluidic die (100) may be a thermal inkjet (TIJ) fluidic die (100).

In another example, the fluid actuator (106) may be a piezoelectric device. As a voltage is applied, the piezoelectric device changes shape which generates a pressure pulse in the fluid chamber that pushes the fluid through the chamber. In this example, the fluidic die (100) may be a piezoelectric inkjet (PLO fluidic die (100).

As described above, such fluid actuators (106) rely on energy to actuate. The energy seen by fluid actuators (106) is based on a voltage potential across the fluid actuator (106). Accordingly, each zone (104) is coupled to a supply and a return. If 1) the supply voltage seen by a zone (104) is less than a predetermined threshold, 2) the return voltage from the zone (104) is greater than a predetermined threshold, or 3) combinations thereof, the voltage potential across the zone (104) may be less than sufficient to facilitate fluid actuation. Accordingly, the fluid actuators (106) in that zone (104) may underperform or may not perform at all. Accordingly, each zone (104) includes fault detection devices that detect either kind of fault, i.e., a fault in the supply side or a fault in the return side. Such fault detection devices operate by comparing either a supply voltage or a return voltage against a respective threshold.

Accordingly, the fluidic die (100) includes at least one comparator (110) that compares at least one of a representation of a supply voltage or a return voltage supplied to the zone (104) against a voltage threshold. That is, each zone (104), based on its position within the array (102) and based on the fluidic die (100) position, among others, on a printing system, may see a different voltage due to different sources of loss along the path between the source and the zone (104). In some examples, the source may be off die and may supply power to multiple die. Accordingly, the comparator determines such losses.

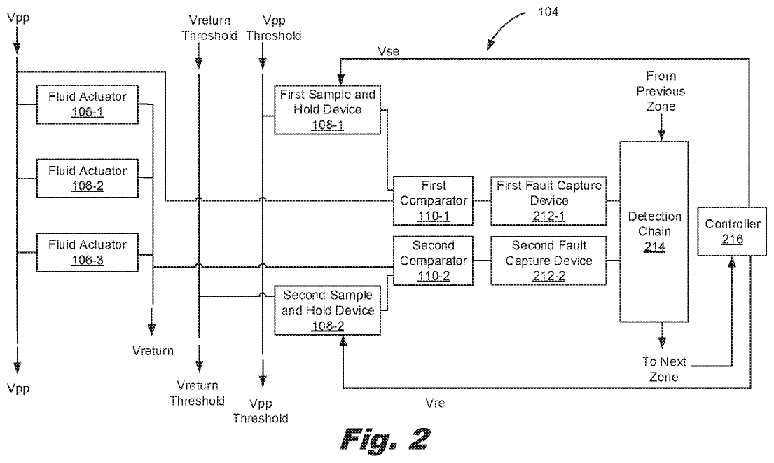

For example, the comparator (110) may compare a representation of a supply voltage supplied to the zone (104) against a supply voltage threshold or may compare a return voltage supplied to the zone (104) against a return voltage threshold. In some examples as depicted in FIG. 2, additional fault detection circuitry can be added such that one determines a supply side fault and the other determines a return side fault.

In another example, additional comparators (110) circuits can be added to analyze different values of voltage differentials. For example, a fluidic die (100) may be supplied with a high voltage, i.e., 32 V, and a low voltage, i.e., 5 V, each with their own returns. In this example, the multiple comparators (110) circuits may analyze the returns corresponding to each supply.

As a specific numeric example, the comparator (110) receives as input, a representation of the supply voltage at this zone (104) and also a supply voltage threshold, which threshold is a cutoff for sending an indication of a supply fault to a controller of the fluidic die (100). For example, if the array (102) is supplied with a supply voltage of 32 V, the supply voltage threshold may be set at 28 V. In this example, the comparator (110) compares the supply voltage seen at the zone (104), which may be less than 32 V against the supply voltage threshold of 28 V. If the supply voltage drops below the threshold value, a fault-indicating output is passed to a controller. Similarly, if the supply voltage seen at the zone (104) does not drop below the threshold value, a non-fault-indicating output is passed to the controller.

In another example, the fault is determined by analyzing a return side of the voltage differential. In this example, the comparator (110) compares a return voltage from the zone (104) against a return voltage threshold. That is, the comparator (110) receives as input, the return voltage leaving this zone (104) and also a return voltage threshold, which threshold is a cutoff for sending an indication of a return fault to a controller of the fluidic die (100). For example, if the array (102) is grounded to 0 V, the return voltage threshold may be set at 3 V. In this example, the comparator (110) compares the return voltage seen at the zone (104), which may be greater than 0 V due to parasitic losses on the return supply line, and compares it against the return voltage threshold of 3 V. If the return voltage rises above the threshold value, a fault indicating output is passed to the controller. Similarly, if the return voltage seen at the zone (104) does not rise above the threshold value, a non-fault indicating output is passed to the controller.

In other words, the comparator (110) generates a signal that either 1) indicates a fault or 2) indicates that the corresponding zone (104) is in a non-fault state. In this case, the fault-indicating output indicates that either 1) that the supply voltage at the zone (104) is less than the supply voltage threshold or 2) that the return voltage at the zone (104) is greater than the return voltage threshold. In one example, the representation of the supply voltage may be the supply voltage, unaltered. In another example, the supply voltage may be scaled, or reduced.

Note that in this example, the comparator (110) can determine a fault either based on a supply voltage or a return voltage within the zone (104). Making such a determination based on just one side of the voltage differential is beneficial in that it reduces the circuitry on a fluidic die (100). Moreover, as the voltage differential between supply and threshold and return and threshold are mirrors, an overall drop in voltage differential based on the supply voltage and return voltage can be determined.

However, long transmission lines throughout the arrays (102) are susceptible to coupled noise from the switching of devices on the fluidic die (100) and to the firing of fluid actuators (106). Such noise can alter the threshold voltages thus resulting in a less accurate fault determination. Accordingly, the fluidic die includes at least one sample and hold device (108) coupled to an input of the comparator (110) that receives the threshold voltages.

Specifically, the sample and hold device (108) is coupled to the comparator (110). This sample and hold device (108) receives and stores a voltage threshold during a predetermined period. This predetermined period may be a period of reduced electrical activity on the fluidic die such as those time periods when there is no data being shifted into the array (102) of fluid actuators (106), when the fluid actuators (106) are not firing, and/or when less than a threshold amount of fluid actuators (106) are firing. In some examples, the predetermined period may be a quiescent period for the fluidic die (100). This determination may be made by a controller. That is, a controller may have data relating to active firings, and active data transfer and can prevent the passing of a threshold voltages at these times. Then during a time of quiescence or reduced electrical activity, the voltage threshold may be passed to the sample and hold device (108). Then at some later point in time, i.e., during actuation, the comparator (110) compares the voltage stored by the sample and hold device (108) with either the representation of the supply voltage or the return voltage. As such, the comparator (110) has a clean, noise-free signal against which the voltage can be compared for an accurate determination of a supply fault in the zone (104). As depicted in FIG. 2, in some examples, multiple sample and hold devices (108) operate together, one to receive a supply voltage threshold and another to receive the return voltage threshold.

Such a fluidic die (00) accounts for drops of power by providing an indication when power levels along the fluidic die (100) are insufficient to effectuate proper fluid actuation. For example, when, due to any number of circumstances, a particular zone (104) does not have sufficient voltage potential between its supply and return terminals to actuate fluid as configured, a fault is triggered and an output passed to a controller of the fluidic die (100) such that a remedial action, such as adjusting the print mask, power distribution, print speed, or firing parameters can be carried out. Moreover, using the sample and hold device (108) increased accuracy is provided to the comparison process so as to avoid false detections of fault and ensure accurate actuator evaluation.

FIG. 2 is a block diagram of a fluidic die (FIG. 1, 100) with sampled and held zonal actuator evaluation thresholds, according to an example of the principles described herein. Specifically, FIG. 2 depicts a zone (104) of an array (FIG. 1, 102). As noted above, a fluidic die (FIG. 1, 100) may include any number of arrays (FIG. 1,102), which arrays (FIG. 1, 102) may be configured in any number of ways, including in columns.

Moreover, as described above, each zone (104) includes a number of fluid actuators (106). For simplicity, in FIG. 2, three fluid actuators (106) are depicted in a zone (104), but a zone (104) may include any number of fluid actuators (106). An energy potential is applied across the fluid actuators (106) in a zone (104) by coupling each zone (104) of fluid actuators (106) to a supply voltage, Vpp, and a return voltage, Vreturn. Each of the supply voltage, Vpp, and the return voltage, Vreturn, are coupled to each zone (104) in the array (FIG. 1, 102). That is, Vpp and Vreturn are global to zones (104) of the array (FIG. 1, 102). However, the voltages of Vpp and Vreturn at each zone (104) may be different due to different levels of parasitic loss along the path. The voltage differential between these two values Vpp and Vreturn at a particular zone (104) indicate whether or not the fluid actuators (106) in that zone (104) are receiving sufficient power to operate as expected. Accordingly, the fault detection circuitry is implemented to measure such a voltage difference and determine whether or not a fault, i.e., an insufficient voltage difference, exists in that zone (104).

As described above, in some examples, the fluidic die (FIG. 1, 100) includes one comparator (110) and one sample and hold device (108) to analyze at least one of a supply voltage and a return voltage against a respective threshold. In some examples, the fluidic die (FIG. 1, 100) includes additional comparators (110) and sample and hold devices (108) as depicted in FIG. 2.

For example, the supply voltage, Vpp, and a supply voltage threshold, Vpp threshold, are passed to a first comparator (110-1). Note that the same voltage supply threshold, Vpp threshold, is globally passed to each zone (104) in an array (FIG. 1, 102) of fluid actuators (106). The first comparator (110-1) compares these two voltages and generates an output that is passed to a first fault capture device (212-1). The first fault capture device (212-1) is a component that receives the output of the first comparator (110-1). The first fault capture device (212-1) in some examples may be coupled to a detection chain (214) on the fluidic die (FIG. 1, 100) that aggregates data stored in other fault capture devices (212) such that an output of a detection chain (214), indicates whether a fault is present on any of the zones (104) within the array (102).

The return voltage, Vreturn, and a return voltage threshold, Vreturn threshold, are passed to a second comparator (110-2). Note that the same return voltage threshold, Vreturn threshold, is globally passed to each zone (104) in an array (FIG. 1, 102) of fluid actuators (106). The second comparator (110-2) compares these two voltages and generates an output that is passed to the second fault capture device (212-2), The second fault capture device (212-2) is a component that receives the output of the second comparator (110-2). The second fault capture device (212-2) in some examples may be coupled to the detection chain (214) which aggregates data stored in other fault capture devices (212) such that an output of a detection chain (214), indicates whether a fault is present on any of the zones (104) within the array (102).

As described above, each of the threshold voltages is passed to a respective sample and hold device (108). That is, the Vpp threshold, which is global, is passed to the first sample and hold device (108-1) of each zone (104) during a predetermined window of electrical inactivity, where it is stored until evaluation. During evaluation, the supply voltage threshold, Vpp threshold, is then passed to the first comparator (110-1) for evaluation.

Similarly, the Vreturn threshold, which is global, is passed to the second sample and hold device (108-2) of each zone (104) during a predetermined window of electrical inactivity, where it is stored until evaluation. During evaluation, the return voltage threshold, Vreturn threshold, is then passed to the second comparator (110-2) for evaluation.

Each of the sample and hold devices (108) is enabled via an enable signal. Specifically, a supply enable signal, Vse, activates the first sample and hold device (108-1) and a return enable signal, Vre, activates the second sample and hold device (108-2). Note that while FIG. 2 depicts separate enable signals for each of the first and second sample and hold devices (108-1, 108-2), in some examples, a single enable signal may activate both the first and second sample and hold devices (108-1, 108-2). As described above, these enable signals activate the sample and hold devices (108-1, 108-2) during the predetermined period and enable the sample and hold devices (108-1, 108-2) to receive the corresponding threshold signal. The enable signals, Vse and Vre, are global meaning that they are passed to each zone (104) of the array (FIG. 1, 102) so that the threshold voltages are sampled in all zones (104) in the array (FIG. 1, 102) at the same time.

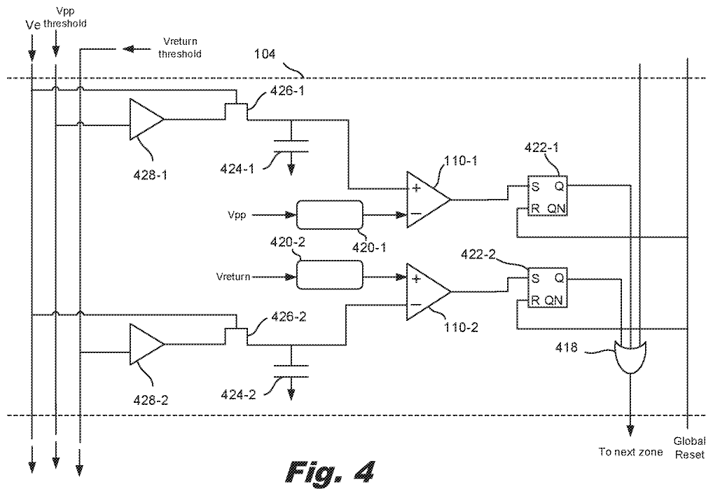

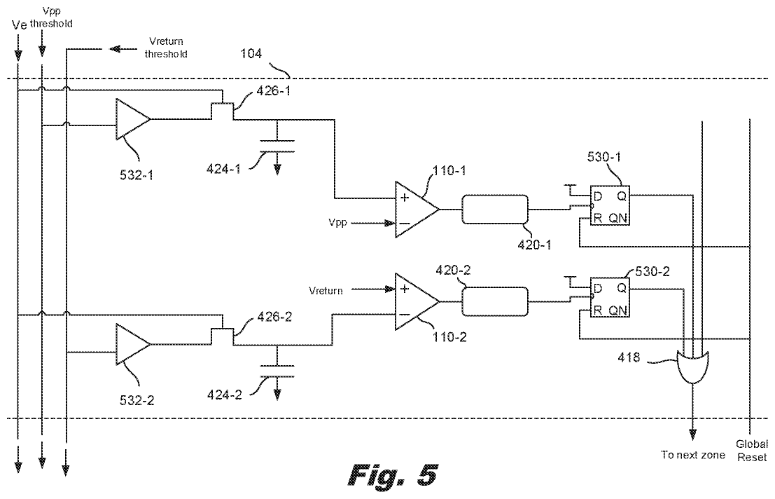

The fluidic die (FIG. 1, 100) in this example includes a detection chain (214) a part of which passes through the zone (104). The detection chain (214) combines outputs of each fault capture device (212) in the array (FIG. 1, 102) such that the contents of all fault capture devices (212) in the array (FIG. 1, 102) are conveyed in a collective fashion to the controller (216). For example, an output of a previous zone (104) is passed to the detection chain (214) where it is aggregated and passed. An output of the first fault capture device (212-1) and the second fault capture device (212-2) are also passed to the detection chain (214) where they are aggregated and passed to a subsequent zone (104). This operation repeats such that an output of the detection chain (214) is a value, which may be a single bit, indicative of a failure somewhere on the array (FIG. 1, 102). An example of circuitry forming the detection chain (214) is provided below in FIGS. 4 and 5.

The fluidic die (FIG. 1, 100) also includes a controller (216) that, in addition to receiving and interpreting the output of the detection chain (214), determines the predetermined period during which the threshold voltages are passed to the respective sample and hold devices (108). The controller (216) also enables storage of the threshold voltages by, for example, sending the enable signals, Vse and Vre, to the sample and hold devices (108-1, 108-2) during the predetermined window.

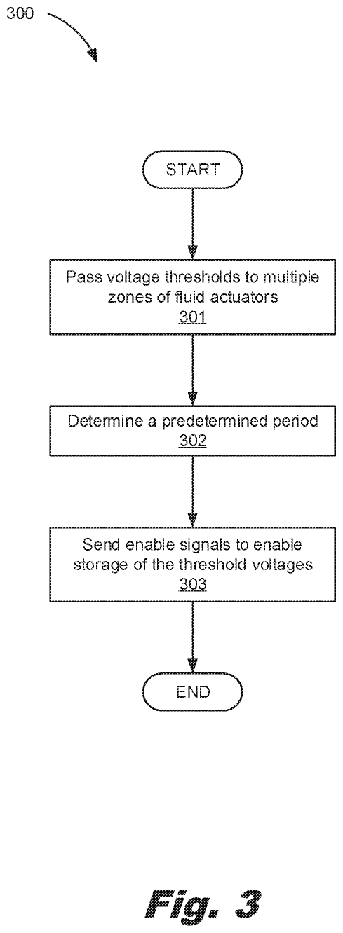

FIG. 3 is a flow chart of a method (300) for zonal actuator evaluation using sampled and held thresholds, according to an example of the principles described herein. According to the method (300), voltage thresholds are passed (block 301) to multiple zones (FIG. 1, 102) of fluid actuators (FIG. 1, 106). Specifically, a global supply voltage threshold, Vpp threshold, is passed to each zone (FIG. 1, 104) and a global return voltage threshold, Vreturn threshold, is passed to each zone (FIG. 1, 104).

A predetermined period is then determined (block 302), during which the threshold voltages are stored in respective sample and hold devices (FIG. 1, 108). The predetermined period refers to a period of time when noise is less likely along the transmission lines as compared to other times of operation. For example, when the fluidic die (FIG. 1, 100) is not actively firing or is not actively switching data into the array (FIG. 1, 102), the noise on the fluidic die (FIG. 1, 100) may be less than when fluid actuators (FIG. 1, 106) are actively firing and data is being switched into the array (FIG. 1, 102). Accordingly, during this period, the threshold voltages that are passed into the respective sample and hold devices (FIG. 1, 108) are less susceptible to the effects of noise. In some examples, the predetermined period may be a quiescent period when the fluidic die (FIG. 1, 100) is inactive, or active up to a certain degree.

When in this predetermined period, enable signals, Vse and Vre, are sent (block 303) to the respective sample and hold devices (FIG. 1, 108) to enable storage of the respective voltage thresholds. That is, the supply enable signal, Vse, is sent to the first sample and hold device (FIG. 1, 108-1) to enable storage of the supply voltage threshold, Vpp threshold, and the return enable signal, Vre, is sent to the second sample and hold device (FIG. 1, 108-2) to enable storage of the return voltage threshold, Vreturn threshold. The method (300) in this fashion enables a clean signal, unfettered by noise from device switching and actuator firing. Note that as described above, a single enable signal may activate both the first sample and hold device (FIG. 2, 108-1) and the second sample and hold device (FIG. 2, 108-2).

FIG. 4 is a circuit diagram of a fluidic die (FIG. 1, 100) with sampled and held zonal actuator evaluation thresholds, according to an example of the principles described herein. Specifically, FIG. 4 is a circuit diagram of a zone (104). As described above, in one example each zone (104) includes a first comparator (110-1) for monitoring the supply voltage, Vpp, and a second comparator (110-2) for monitoring the return voltage, Vreturn, which return voltage is the supply that returns current from the fluidic actuators (FIG. 1, 106) back to the power supply device. Also, as described above, each zone (104) includes fault capture devices (FIG. 2, 212). In the example depicted in FIG. 4, the fault capture devices (FIG. 2, 212) are S-R flops (422-1, 422-2).

An example of the operation of this example is now provided. Prior to any fault detection, an output of each comparator (110-1, 110-2) may indicate expected operation, in this example represented by logic “0.” This value is passed to the “S” terminal of the S-R flops (422-1, 422-2) and set on the output terminal “Q.” As described above, each fault capture device (FIG. 2, 212) is coupled to detection chain (FIG. 2, 214) logic that aggregates the output of this zone (104) with that of other zones (104). In this example, that logic may implement an OR gate (418). The OR gate (418) outputs a signal indicating a fault when 1) the first S-R flop (422-1) indicates a fault, 2) the second S-R flop (422-2) indicates a fault, or 3) any upstream zone (104) indicates a fault, wherein a fault is indicated with a logic “1.” If no fault is indicated on any input of the OR gate (418) an output of “0” passes to the next zone (104) and the process repeats.

In this example, the first comparator (110-1) has its “+” terminal indirectly connected to the supply threshold voltage, Vpp threshold, which is provided globally to all zones (104). That is, the supply threshold voltage, Vpp threshold, passes through a first sample and hold device (FIG. 1, 108-1) which sample and hold device includes a first capacitor (424-1) to store the supply voltage threshold, Vpp threshold, until evaluation and a first transistor (426-1) to allow the supply voltage threshold, Vpp threshold, to pass to the first capacitor (424-1) during the predetermined period. That is, the first sample and hold device (FIG. 1, 108-1) includes an analog switch, i.e., the first transistor (426-1) that is controlled by a digital signal, Ve, and passes the global supply voltage threshold, Vpp threshold, to a capacitor (424-1) which maintains the voltage until it is refreshed with a subsequent sample event. As described above, the enable signal, Ve, is sent during a time identified to have minimal switching noise on the rest of the fluidic die (FIG. 1, 100). Note that in the example depicted in FIG. 4, a single enable signal, Ve, activates both sample and hold devices (FIG. 1, 108).

The “−” terminal of the first comparator (110-1) is connected to the representation of the supply voltage, Vpp. Note that in some examples, the supply voltage first passes through a low pass filter (420-1, 420-2). In the example depicted in FIG. 4, the low pass filters (420-1, 420-2) are disposed on an input of a respective comparator (110-1, 110-2) on which a supply voltage or return voltage are received. However, as depicted in FIG. 5, in some examples the low pass filters (420-1, 420-2) may be disposed on an output of a respective comparator (110-1, 110-2). In other examples, the comparators (110-1, 110-2) themselves may perform a filtering function. The low pass filters (420) filter out noise that may be found along the path of the supply and return voltages. Such noise may cause false triggers. Accordingly, the low pass filters (420) prevent such false fault triggers.

During operation, the first comparator (110-1) maintains a “0” logic, indicating expected operation, i.e., that the supply voltage, Vpp, at the zone (104) is greater than or equal to the supply voltage threshold, Vpp threshold. In the event that the supply voltage, Vpp, falls below the threshold, Vpp threshold, the output of the first comparator (110-1) will transition from a “0” to a “1” causing the S-R flop (422-1) to be set to a “1” and output that “1” along the “Q” terminal to be processed at the OR gate (418). This “1” indicating a supply fault will be communicated to the global die logic, and possibly to the printer, via a detection chain (FIG. 2, 214) that combines the fault signals from the S-R flops (422) of each zone (104). This “1” will remain on the first S-R flop (422-1) until the first S-R flop (422-1) is reset. That is, a reset device, in this example the “R” terminal and the global reset line, resets the respective fault capture device (FIG. 2, 212), in this example, the S-R flops (422-1, 422-2) after the fault has been acknowledged by a controller (FIG. 2, 216).

The “+” terminal of the second comparator (110-2) is connected to the return voltage, Vreturn, which may first pass through a low pass filter (420-2). The “+” terminal of the second comparator (110-2) is indirectly connected to the return threshold voltage, Vreturn threshold, which is provided globally to all zones (104). That is, the supply threshold voltage, Vreturn threshold, passes through a second sample and hold device (FIG. 1, 108-2) which sample and hold device includes a second capacitor (424-2) to store the return voltage threshold, Vreturn threshold, until evaluation and a second transistor (426-2) to allow the return voltage threshold, Vreturn threshold, to pass to the second capacitor (424-2) during the predetermined period. That is, the second sample and hold device (FIG. 1, 108-2) includes an analog switch, i.e., the second transistor (426-2) that is controlled by a digital signal, Ve, and passes the global return voltage threshold, Vreturn threshold, to a capacitor (424-2) which maintains the voltage until it is refreshed with a subsequent sample event. As described above, the enable signal, Ve, is sent during a time identified to have minimal switching noise on the rest of the fluidic die (FIG. 1, 100).

During operation, the second comparator (110-2) maintains a “0” logic, indicating expected operation, i.e., that the return voltage, Vreturn, from the zone (104) is less than or equal to the return voltage threshold, Vreturn threshold. In the event that the return voltage, Vreturn, rises above the threshold, Vreturn threshold, the output of the second comparator (110-2) will transition from a “0” to a “1” causing the second S-R flop (422-2) to be set to a “1” and output that “1” along the “Q” terminal to be processed at the OR gate (418). This “1” indicating a return fault will be communicated to the global die logic, and possibly to the printer, via a detection chain (FIG. 2, 214) that combines the fault signals from the S-R flops (422) of each zone (104). This “1” will remain on the second S-R flop (422-2) until the second S-R flop (422-2) is reset.

In some examples, a buffer (428-1, 428-2) is disposed at an input of each of the first sample and hold device (FIG. 1, 108-1) and the second sample and hold device (FIG. 1, 108-2). That is, the buffer (428-1, 428-2) are disposed upstream of the transistors (426-1, 426-2). The buffers (426-1, 426-2) ensure that the voltage threshold lines are not overloaded. If these lines become overloaded, the voltages may not settle in time allowed during the predetermined, low noise, period.

FIG. 5 is a circuit diagram of a fluidic die (FIG. 1, 100) with sampled and held zonal actuator evaluation thresholds, according to another example of the principles described herein. As described above, each zone (104) includes fault capture devices (FIG. 2, 212). In the example depicted in FIG. 5, the fault capture devices (FIG. 1, 112) are D-flops (530-1, 530-2).

An example of the operation of this example is now provided. Prior to any fault detection, an output of each comparator (110-1, 110-2) may indicate expected operation, in this example represented by logic “0.” This output of the comparator (110) is coupled to the clock signal of the D-flops (530-1, 530-2). Note that in this example, the low pass filters (420-1, 420-2) are coupled to the output of the comparators (110-1, 110-2), but having the same effect of filtering out noise and preventing false indications of fault.

As described above, each fault capture device (FIG. 2, 212) is coupled to logic that aggregates the output of this zone (104) with that of other zones (104). In this example, that logic may implement an OR gate (418). In this example, the OR gate (418) outputs a signal indicating a fault when 1) the first D-flop (530-1) indicates a fault, 2) the second D-flop (530-2) indicates a fault, or 3) any upstream zone (104) indicates a fault, wherein a fault is indicated with a logic “1.” If no fault is indicated on any input of the OR gate (418) an output of “0” passes to the next zone (104) and the process repeats.

In this example, the first comparator (110-1) has its “+” terminal indirectly connected to the VPP threshold voltage, Vpp threshold, which is provided globally to all zones (104). The “−” terminal of the first comparator (110-1) is connected to the representation of the supply voltage, Vpp.

During operation, the first comparator (110-1) maintains a “0” logic, indicating expected operation, i.e., that the supply voltage, Vpp, at the zone (104) is greater than or equal to the supply voltage threshold, Vpp threshold. In the event that the supply voltage, Vpp, falls below the threshold, Vpp threshold, the output of the first comparator (110-1) will transition from a “0” to a “1” causing the first D-flop (530-1) to clock in a “1” which will then appear on the output “Q” terminal of the first D-flop (530-1). This “1” indicating a supply fault will be communicated to the global die logic, and possibly to the printer, via a detection chain (FIG. 2, 214) that combines the fault signals from the D-flops (530) of each zone (104). This “1” will remain on the first D-flop (530-1) until the first D-flop (530-1) is reset, That is, a reset device, in this example the “R” terminal and the global reset line, resets the respective fault capture device (FIG. 2, 212), in this example, the D-flops (530) after the fault has been acknowledged by a controller (FIG. 2, 216).

In this example, the second comparator (110-2) has its “−” terminal indirectly connected to the Vreturn threshold voltage, Vreturn threshold, through the second sample and hold device (FIG. 1, 108-2). The “+” terminal of the second comparator (110-2) is connected to the return voltage, Vreturn.

During operation, the second comparator (110-2) maintains a “0” logic, indicating expected operation, i.e., that the return voltage, Vreturn, from the zone (104) is less than or equal to the return voltage threshold, Vreturn threshold. In the event that the return voltage, Vreturn, rises above the threshold, Vreturn threshold, the output of the second comparator (110-2) will transition from a “0” to a “1” causing the second D-flop (530-2) to clock in a “1” which will then appear on the output “Q” terminal of the second D-flop (530-2) and output that “1” along the “Q” terminal to be processed at the OR gate (418). This “1” indicating a return fault will be communicated to the global die logic, and possibly to the printer, via a detection chain (FIG. 2, 214) that combines the fault signals from the D flops (530) of each zone (104). This “1” will remain on the second D flop (530-2) until the second D-flop (530-2) is reset.

In some examples, a scaler (532-1, 532-2) is disposed at an input of each of the first sample and hold device (FIG. 1, 108-1) and the second sample and hold device (FIG. 1, 108-2). That is, the scalers (532-1, 532-2) are disposed upstream of the transistors (426-1, 426-2). The scalers (532-1, 532-2) scale a large voltage to a low voltage. For example, a 5 V signal may be less susceptible to noise and this be passed along the threshold transmission lines. However, it may be desired that the input to the comparators (110) be a lower value. Accordingly, the scalers (532-1, 532-2) scale a signal having a strength that is less susceptible to noise, to a desired level to be input into the comparators (110).

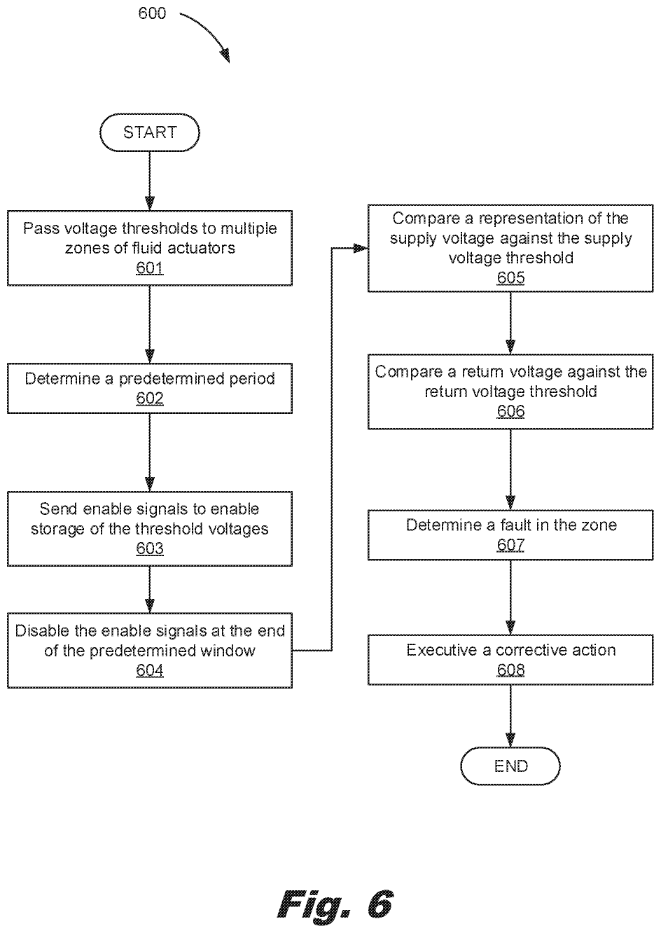

FIG. 6 is a flow chart of a method (600) for zonal actuator evaluation, according to an example of the principles described herein. According to the method (600), voltage thresholds are passed (block 601) to multiple zones (FIG. 1, 104) of fluid actuators (FIG. 1, 106) and a predetermined period is determined (block 602). This may be performed as described above in connection with FIG. 3. During the predetermined period of time, enable signals are sent (block 603) to enable storage of the threshold voltages. This also may be performed as described above in connection with FIG. 3. Once the predetermined period is done, i.e., before sources of potential noise are again active on the fluidic die (FIG. 1, 100), the enable signals are disabled (block 604) such that the noise will not contaminate the threshold voltages as stored on the sample and hold devices (FIG. 1, 108).

Then, during evaluation, a representation of a supply voltage, Vpp, supplied to a particular zone (FIG. 1, 104) is compared (block 605) against a supply voltage threshold, Vpp threshold as it is received from the first sample and hold device (FIG. 1, 108-1). As described above, this may occur at the first comparator (FIG. 1, 110-1) of the zone (FIG. 1, 104). The supply voltage threshold, Vpp threshold, may be any value less than the supply voltage, Vpp, where it is deemed that sub-threshold voltages would result in less than a desired level of performance by the fluid actuators (FIG. 1, 106) in that zone (FIG. 1, 104). Note also that the supply voltages, Vpp, may differ at different zones (FIG. 1, 104). Accordingly, by comparing the supply voltage threshold, Vpp threshold, with the specific supply voltage, Vpp, seen at a zone (FIG. 1, 104), a localized result based on the actual operation of a particular fluid system can be determined.

As noted the representation of the supply voltage, Vpp, may include the actual supply voltage itself or a scaled version. The scaled version may be desirable for example, when the first comparator (FIG. 1, 110-1) is a low-voltage comparator, for consistency with the second comparator (FIG. 1, 110-2) which may be a low-voltage comparator. In this example, a high voltage source may damage the low-voltage first comparator (FIG. 1, 110-1).

Still during this evaluation period, the return voltage, Vreturn, from a particular zone (FIG. 1, 104) is compared (block 606) against a return voltage threshold, Vreturn threshold as it is received from the second sample and hold device (FIG. 1, 108-2). As described above, this may occur at the second comparator (FIG. 1, 110-2) of the zone (FIG. 1, 104). The return voltage threshold, Vreturn threshold, may be any value greater than the return voltage, Vreturn, where it is deemed that supra-threshold voltages would result in a less than desired level of performance by the fluid actuators (FIG. 1, 106) in that zone (FIG. 1, 104). Note also that the return voltages may vary between zones (FIG. 1, 104). Accordingly, by comparing the return voltage threshold, Vreturn threshold, with the specific return voltage, Vreturn, seen at a zone (FIG. 1, 104), a localized result based on the actual operation of a particular fluid system can be determined.

With these comparisons (block 605, 606) made, the system can determine (block 607) a fault in the zone (FIG. 1, 104). Specifically, a fault is determined (block 607) when either 1) the supply voltage, Vpp, at the zone (FIG. 1, 104) is less than the supply voltage threshold, Vpp threshold or 2) the return voltage, Vreturn, at the zone (FIG. 1, 104) is greater than the return voltage threshold, Vreturn threshold. For example, given a supply voltage threshold of 32 V and a return voltage threshold of 3 V, a fault may be determined when the supply voltage, Vpp, at the zone (FIG. 1, 104) falls below 28 V or the return voltage, Vreturn, at the zone (FIG. 1, 104) is greater than 3 V When either of these cases exists, it is indicative that a voltage potential across the zone (FIG. 1, 104) is insufficient to allow fluid actuator (FIG. 1, 106) operation as intended.

A signal indicative of a fault in any of the zones (FIG. 1, 104) is then propagated down a detection chain (FIG. 2, 214) to a controller. That is, a detection chain (FIG. 2, 214) passes by all zones (FIG. 1, 104) and more particularly past all fault capture devices (FIG. 2, 212). In one example, outputs of each fault capture device (FIG. 2, 212) are logically combined into a single aggregate signal such that an output of the detection chain (FIG. 2, 214) indicates a fault somewhere within the array (FIG. 1, 102). Accordingly, the method (600) as described herein describes detection of a fault on the fluidic die (FIG. 1, 100) based on the specific operating parameters, i.e., Vpp and Vreturn, for that particular zone (FIG. 1, 104).

Corrective actions may then be executed (block 608) based on an indication of the fault. For example, print masks, power settings may, print speeds, firing parameters, and other parameters may be adjusted. In one example, the corrective action includes providing a notification to a printer or a user such that manual corrective actions such as maintenance or replacement may occur. Following such corrective action, the fault capture devices (FIG. 2, 212) may be reset to no longer indicate a fault.

In one example, using such a fluidic die 1) allows for immediate detection of power faults at a zone level; 2) reports such faults such that remedial action may be taken; 3) allows for a controller to adjust print masks, power distribution, print speed, or other firing parameters, on the fly to optimize for the actual power delivery limitations of the system; 4) may leverage circuitry used for other zonal sensing systems such as drive bubble detection systems; 5) provides noise free threshold voltages to the zones for improved fault detection.

What is claimed is:

1. A fluidic die comprising:
an array of fluid actuators grouped into zones, each zone comprising:
at least one comparator to compare at least one of a representation of a supply voltage and a return voltage supplied to a zone of fluid actuators against a voltage threshold;
at least one sample and hold device to:
receive and store the voltage threshold during a predetermined period; and
pass the voltage threshold to the at least one comparator during evaluation.

2. The fluidic die of claim 1, wherein:
the at least one comparator comprises:
a first comparator to compare the representation of the supply voltage against a supply voltage threshold; and
a second comparator to compare the return voltage against a return voltage threshold; and
the at least one sample and hold device comprises:
a first sample and hold device to receive and store the supply voltage threshold during the predetermined period and pass the supply voltage threshold to the first comparator; and
a second sample and hold device to receive and store the return voltage threshold during the predetermined period and pass the return voltage threshold to the second comparator.

3. The fluidic die of claim 2, wherein at least one of the supply voltage threshold and return voltage threshold are global to multiple zones of fluid actuators.

4. The fluidic die of claim 1, wherein the predetermined period of time is a period of reduced electrical activity on the fluidic die.

5. The fluidic die of claim 1, further comprising: a low pass filter disposed at an input of the at least one sample and hold device.

6. The fluidic die of claim 1, further comprising: a buffer disposed at an input of the at least one sample and hold device.

7. The fluidic die of claim 1, further comprising: a scaler disposed at an input of the at least one sample and hold device.

8. The fluidic die of claim 1, wherein at least one of the first sample and hold device and the second sample and hold device are activated to receive the respective voltage thresholds via a global enable signal passed to multiple zones of fluid actuators.

9. The fluidic die of claim 1, further comprising at least one fault detection device to output a signal indicating a fault based on at least one of:
a fault-indicating output of the first comparator; and
a fault-indicating output of the second comparator, wherein:
the fault-indicating output of the first comparator indicates the supply voltage is less than the supply voltage threshold; and
the fault-indicating output of the second comparator indicates the return voltage is greater than the return voltage threshold.

10. A fluidic die, comprising:
an array of fluid actuators grouped into zones, each zone comprising:
a number of fluid actuators;
multiple comparators to compare representations of a supply voltage and a return voltage against respective voltage thresholds;
multiple sample and hold devices, each coupled to a respective comparator, to:
receive and store the voltage thresholds during a predetermined period; and
pass the voltage thresholds to the comparators during evaluation;
a number of fault capture devices to store a signal indicating a fault based on an output of at least one of the comparators, wherein the output of the fault detection logic circuits is triggered when an output of at least one of the comparators indicates a fault;
a detection chain to combine outputs of each fault capture device such that the contents of all fault capture devices in the array are conveyed in a collective fashion to a controller; and
the controller to:
determine the predetermined period;
enable storage of the voltage thresholds at the sample and hold devices during the predetermined period.

11. The fluidic die of claim 10, wherein at least one of the sample and hold devices comprises:
a capacitor to store the respective voltage thresholds until evaluation; and
a transistor to allow the respective voltage thresholds to pass to the capacitor during the predetermined period.

12. A method comprising:
passing a supply voltage threshold to multiple zones of fluid actuators;
passing a return voltage threshold to the multiple zones of fluid actuators;
determining a predetermined period; and
during the predetermined period:
sending a supply enable signal to enable storage of the supply voltage threshold in a first sample and hold device; and
sending a return enable signal to enable storage of the return voltage threshold in a second sample and hold device.

13. The method of claim 12, further comprising:
comparing a representation of a supply voltage supplied to a zone of fluid actuators against the supply voltage threshold;
comparing a return voltage from the zone of fluid actuators against the return voltage threshold; and
determining a fault in the zone when at least one of the following conditions exists:
the supply voltage is less than the supply voltage threshold; and
the return voltage is greater than the return voltage threshold.

14. The method of claim 13, further comprising executing a corrective action based on an indication of the fault.

15. The method of claim 12, further comprising disabling the supply enable signal and the return enable signal at the end of the quiescent period.
